(19) United States
(12) Patent Application Publication
(10) Pub. No.: US 2003/0110269 A1
(43) Pub. Date: Jun. 12, 2003

(54) Method and system for wireless management of servers

(75) Inventor: Jerry Chen, Tu-Cheng City (TW)

Correspondence Address: Finnegan, Henderson, Farabow,, Garrett & Dunner, L.L.P., 1300 I Street, N.W., Washington, DC, 20005-3315, US

(73) Assignee: MICRO-STAR INT'L CO., LTD.

(21) Appl. No.: 10/004,883

(22) Filed: Dec. 7, 2001

(51) Int. Cl. G06F 15/16

(52) U.S. Cl. 709/228; 709/223

(57) ABSTRACT

In a method and system for wireless management of a server, an electronic apparatus is connected to a first wireless transmission device having a first identification code exclusive thereto. The server is connected to a second wireless transmission device having a second identification code exclusive thereto. A wireless communications link is established between the electronic apparatus and the server via the first and second wireless transmission devices.

### BACKGROUND OF THE INVENTION

1. Field of the Invention

The invention relates to a server management method and system, more particularly to a method and system for wireless management of servers.

2. Description of the Related Art

With the progress of technology and the rise in the popularity of the Internet, servers, which play many important roles in the Internet, such as browser identity management, web site management, data storage, etc., have become very common. Generally, for purposes of security and convenient management, servers are accommodated in a machine room leased from a machine room provider (such as a telecommunications company) As the space available in the machine room is limited, the greatest number of servers that can be disposed in the machine room is generally taken into account when renting out the machine room. Therefore, if a portion of the space inside the machine room is allocated for purposes other than for placing servers, the number of servers that can be disposed in the machine room will be reduced. In addition, for the sake of maintaining the quality of Internet transmission and quick repair in case of need, server setup and monitoring management has become an important topic in the industry.

Conventional server management methods and systems generally fall into three main types. In the first type, which is illustrated in FIG. 1, the operator is required to move a monitoring terminal 1, which includes a screen 11, a keyboard 12 and a mouse 13, toward a selected server 10 to connect the terminal 1 with the latter via transmission lines in order to retrieve information from or setup the selected server 10 with the aid of the keyboard 12 or mouse 13, while monitoring the status of the selected server 10 on the screen 11, which is very inconvenient due to the need to repeatedly connect and disconnect the transmission lines. Besides, the operator can only monitor one server 10 at a time. If there is any problem with a web site, the operator has to check each server 10 individually in order to find out and solve the problem, which is very inefficient and inconvenient in terms of monitoring management. In addition, space has to be reserved for the terminal 1 in the already crowded machine room.

The second and third conventional server management methods are both illustrated in FIG. 2. In the former, the servers 10 are connected to a data switch 21, and a monitoring terminal 2, which includes a screen 22, a keyboard 23 and a mouse 24, is connected to an input port of the data switch 21 to setup or monitor the selected server 10 via the data switch 21. Thus, there is no need to move the terminal 2 to connect directly with the selected server 10. However, as the number of input/output ports in the data switch 21 and the lengths of the connecting lines are limited, these devices are confined within the same machine room. Therefore, space has to be allocated for accommodating the data switch 21 and the terminal 2. In the third type, the servers 10 are linked to the Internet via network lines, such as a network hub 20. When these servers 10 are connected to the Internet, a remote computer 25 can be connected to the servers 10 via the Internet and the network hub 20 so as to control and monitor the servers 10 selectively. However, the computer 25 is able to setup and monitor the servers 10 only when an Internet connection is available. If connection to the Internet is interrupted, the computer 25 loses control over the servers 10, which is undesirable in terms of security.

### SUMMARY OF THE INVENTION

Therefore, the main object of the present invention is to provide a method and system for wireless management of servers so as to overcome the aforesaid drawbacks of the prior art.

According to one aspect of the invention, a method for wireless management of a server comprises the steps of:

providing an electronic apparatus that is operable so as to issue commands for the server;

connecting a first wireless transmission device to the electronic apparatus, the first wireless transmission device having a first identification code exclusive thereto;

connecting a second wireless transmission device to the server, the second wireless transmission device having a second identification code exclusive thereto;

storing the second identification code in the first wireless transmission device; and

establishing a wireless communications link between the electronic apparatus and the server via the first and second wireless transmission devices.

When the electronic apparatus is operated to issue a command to the server, the first wireless transmission device transmits a wireless output that includes the command, the first identification code exclusive to the first wireless transmission device to serve as an origin code, and the second identification code exclusive to the second wireless transmission device to serve as a destination code.

When the second wireless transmission device receives the wireless output, the second wireless transmission device provides the command in the wireless output to the server only upon verification that the destination code matches the second identification code exclusive thereto.

Preferably, the second wireless transmission device stores the first identification code therein upon verification that the destination code matches the second identification code exclusive thereto.

The server is capable of generating a warning signal upon detection of a server abnormality or server problem and of providing a monitoring report in response to a request from the electronic apparatus. Upon receipt of either one of the warning signal and the monitoring report from the server, the second wireless transmission device transmits a wireless signal that includes said either one of the warning signal and the monitoring report, the first identification code exclusive to the first wireless transmission device to serve as a destination code, and the second identification code exclusive to the second wireless transmission device to serve as an origin code. When the first wireless transmission device receives the wireless signal, the first wireless transmission device provides said either one of the warning signal and the monitoring report in the wireless signal to the electronic apparatus only upon verification that the destination code matches the first identification code exclusive thereto.

According to another aspect of the invention, a system for wireless management of a server comprises: an electronic apparatus operable so as to issue commands for the server; a first wireless transmission device connected to the electronic apparatus and having a first identification code exclusive thereto; and a second wireless transmission device adapted to be connected to the server and having a second identification code exclusive thereto. The second identification code is stored in the first wireless transmission device. The first and second wireless transmission devices cooperate to establish a wireless communications link between the electronic apparatus and the server. When the electronic apparatus is operated to issue a command to the server, the first wireless transmission device transmits a wireless output that includes the command, the first identification code exclusive to the first wireless transmission device to serve as an origin code, and the second identification code exclusive to the second wireless transmission device to serve as a destination code. When the second wireless transmission device receives the wireless output, the second wireless transmission device provides the command in the wireless output to the server only upon verification that the destination code matches the second identification code exclusive thereto.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view illustrating a first conventional server management method;

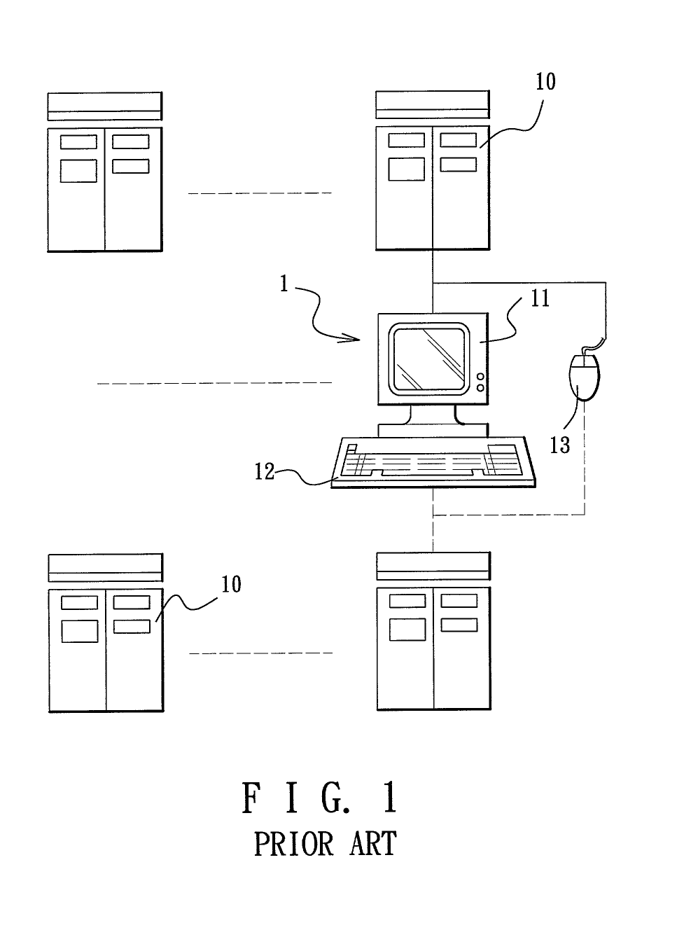

FIG. 2 is a schematic view illustrating second and third conventional server management methods;

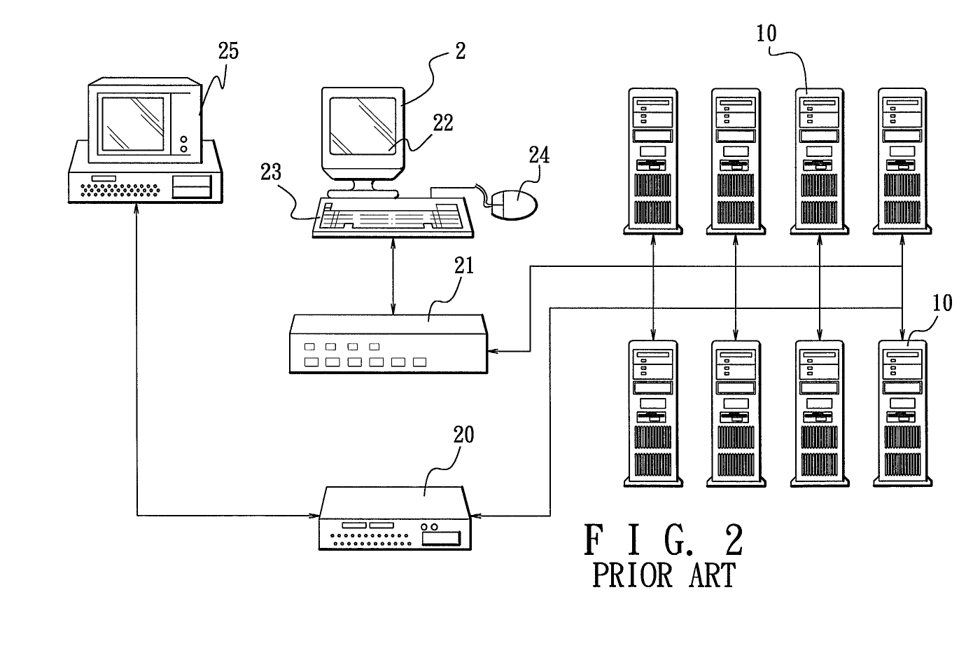

FIG. 3 is a block diagram illustrating the preferred embodiment of a system for wireless management of a server in accordance with the present invention;

FIG. 4 is a schematic view illustrating one implementation of the preferred embodiment;

FIG. 5 is a flowchart illustrating the server wireless management method of the preferred embodiment; and

FIG. 6 illustrates another implementation of the preferred embodiment.

### DETAILED DESCRIPTION OF THE PREFERRED EMBODIMENT

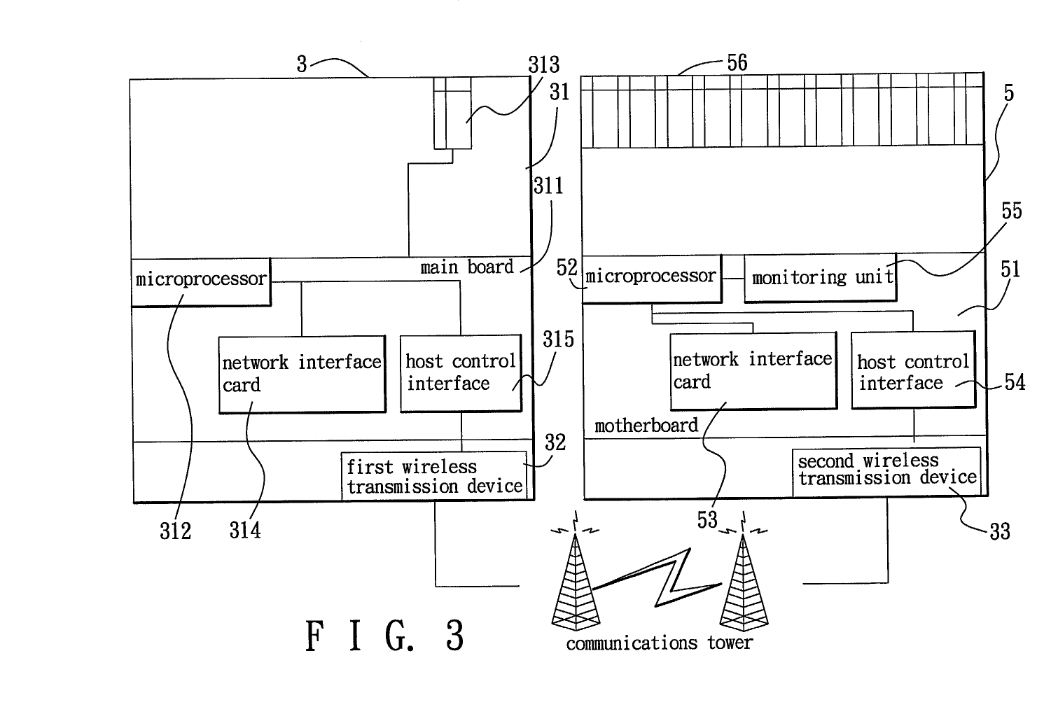

Referring to FIG. 3, the preferred embodiment of a wireless management system 3 according to the present invention is used to setup and monitor at least one server 5 (only one is shown in FIG. 3) via wireless transmission. The wireless management system 3 includes electronic apparatus 31, a first wireless transmission device 32, and at least one second wireless transmission device 33 (only one is shown in FIG. 3).

The electronic apparatus 31 includes a main board 311, a microprocessor 312 disposed on the main board 311, a data storage medium 313, a network interface card 314 plugged on the main board 311, and a host control interface 315 disposed on the main board 311. The microprocessor 312 is connected electrically to and controls operation of the main board 311, the data storage medium 313, the network interface card 314, and the host control interface 315. The storage medium 313 stores application software for accessing and setting up the server 5, communication protocol software, operating software, etc. In this embodiment, the data storage medium 13 is a hard disk. The network interface card 314 is controlled by the microprocessor 312 to modulate digital signals into analog signals for transmission via the Internet, and to convert analog signals received via the Internet into digital signals. According to the communication protocol software, such as the Transmission Control Communication Protocol/Internet Protocol (hereinafter referred to as TCP/IP) software, stored in the data storage medium 313, packet construction and data reconstruction operations proceed under the control of the microprocessor 312. The host control interface 315 is connected electrically to the data storage medium 313 to bridge the first wireless transmission device 32 and the electronic apparatus 31. Although the data storage medium 313 in this embodiment is a hard disk, it is well known to those skilled in the art that the data storage medium 313 should not be limited thereto, and other types of data storage mediums, such as rewritable optical discs, can also be used in actual practice.

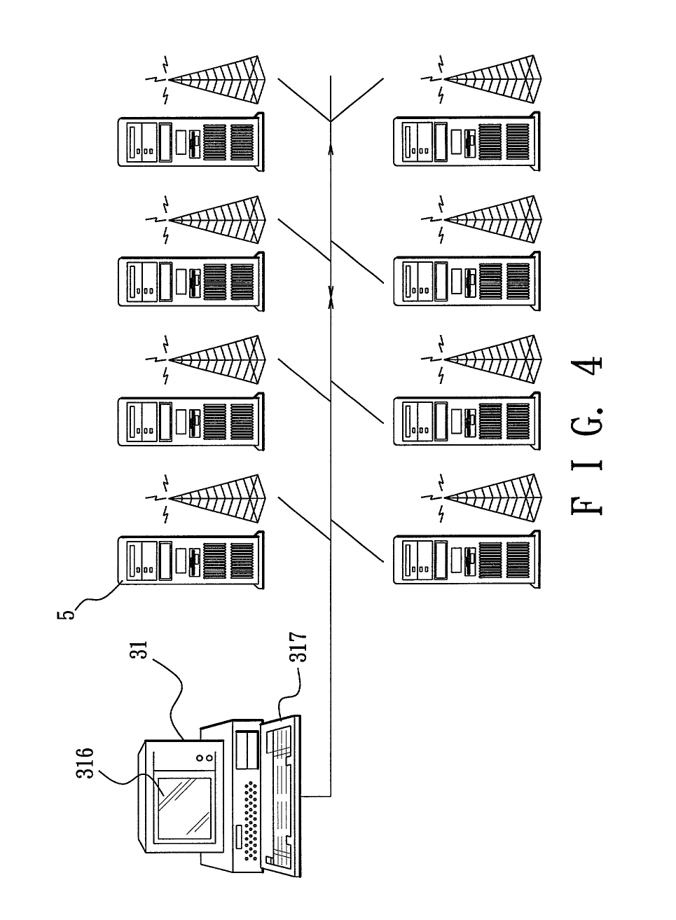

The first wireless transmission device 32 is connected electrically to the host control interface 315 for converting control signals received by the host control interface 315 from the electronic apparatus 31 into a radio wave output, and for receiving radio signals and for converting the same into electrical signals that are to be supplied to the electronic apparatus 31 via the host control interface 315. The first wireless transmission device 32 has an exclusive first identification code, and stores a second identification code exclusive for each second wireless transmission device 33. When the first wireless transmission device 32 converts the control signals into the radio wave output, the first and second identification codes will be converted as well, with the first identification code serving as an origin code and the second identification code serving as a destination code, so as to ensure that the second transmission device 33 is aware that the radio wave output is transmitted thereto from the electronic apparatus 31. The specification of the first wireless transmission device 32 is determined by the system designer, and can be one that conforms to the infrared communication standard, the Bluetooth communication standard, the IEEE 802.11b standard, the Wireless Application Protocol (hereinafter referred to as WAP), or any other wireless transmission standard. In this embodiment, the first wireless transmission device 32 is compliant with the Bluetooth communication standard, and can be built into the electronic apparatus 31. The electronic apparatus 31 can be in the form of a personal computer (see FIG. 4). The electronic apparatus 31 further includes a screen 316 and a user input device 317.

Each server 5 is used in conjunction with a second wireless transmission device 33. The second transmission device 33 is connected electrically to the respective server 5 and has the same specification as the first wireless transmission device 32. As such, the second transmission device 33 in this embodiment is compliant with the Bluetooth communication standard. When the second wireless transmission device 33 receives the radio wave output, it will compare the destination code and the exclusive identification code thereof to determine if they match. When a match is detected, this indicates that the radio wave output is addressed to the second wireless transmission device 33, and the second wireless transmission device 33 will proceed to convert the radio wave output into an electronic signal to be supplied to the corresponding server 5, and will store the first identification code. Otherwise, the radio wave output will be ignored. Furthermore, when a signal is to be transmitted from the server 5 to the electronic apparatus 31 via the corresponding second wireless transmission device 33, the second wireless transmission device 33 will set the first identification code as the destination code and the second identification code exclusive thereto as the origin code. The destination and origin codes, together with the signal to be transmitted by the respective server 5, will be converted by the second wireless transmission device 33 into a radio signal for broadcasting. When the first wireless transmission device 32 receives the radio signal, it will provide the same to the electronic apparatus 31 after making a comparison. Hence, the electronic apparatus 31 will be able to know from which server 5 the signal originated.

Referring to FIG. 3, the server 5 includes a motherboard 51, a microprocessor 52 disposed on the motherboard 51, a network interface card 53, a host control interface 54, a monitoring unit 55, and a plurality of data storage media 56. The microprocessor 52 is connected electrically to and controls operation of the motherboard 51, the network interface card 53, the host control interface 54, the monitoring unit 55, and the data storage media 56. The network interface card 53 has the same functions as that of the electronic apparatus 31. That is, the network interface card 53 is controlled by the microprocessor 52 to modulate digital signals into analog signals for transmission via the Internet, and to convert analog signals received via the Internet into digital signals. According to communication protocol software, such as TCP/IP software, stored in the data storage media 56, packet construction and data reconstruction operations proceed under the control of the microprocessor 52. The host control interface 54 bridges the network interface card 53 and the second wireless transmission device 33 so that information can be transmitted therebetween via the host control interface 54. The monitoring unit 55 is disposed to monitor the operating environment of the server 5. In this embodiment, the monitoring unit 55 is employed to monitor the temperature of the server 5 and to send a warning signal to the electronic apparatus 31 (to be described hereinafter) when the detected temperature is higher than a predetermined value. The monitoring unit 55 also monitors the operation of the system and generates monitoring reports. The data storage media 56 are used to store server setup application software, communication protocol software, monitoring software, Internet information providing software, Internet information management software, operating software, and the like. In this embodiment, the storage media 56 are hard disks. Although the storage media 56 in this embodiment are hard disks and the server 5 has a motherboard 51, it is apparent to those skilled in the art that the type of the storage media 56 and the number of motherboards 51 in the server 5 can vary according to actual requirements, and should not be limited to the embodiment described above.

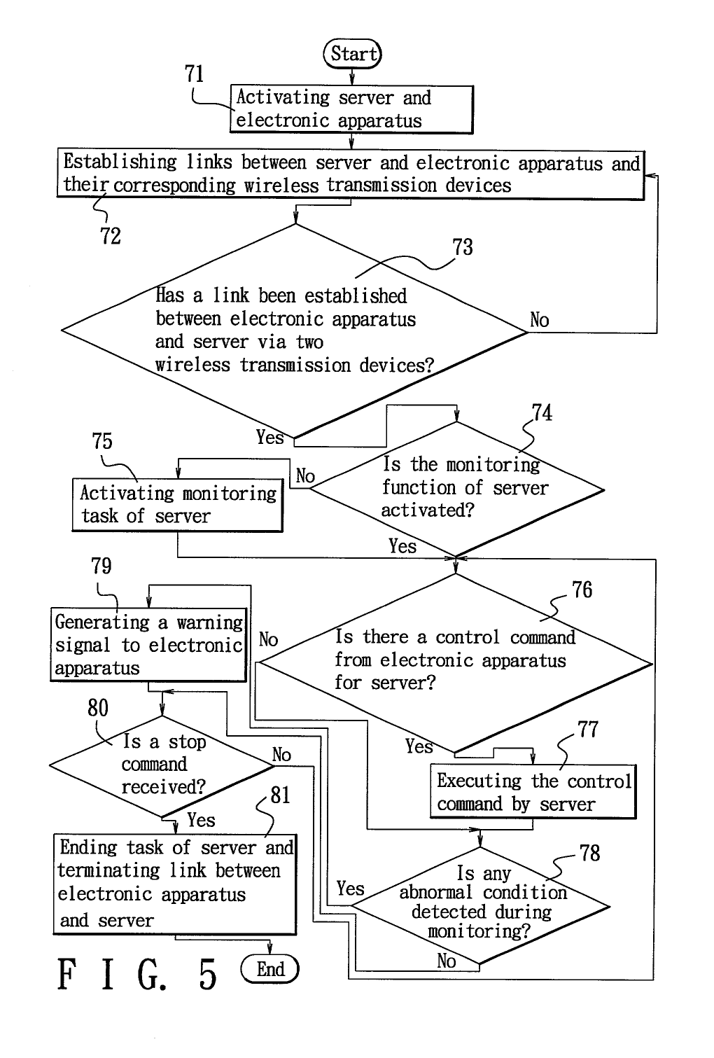

Based on the construction of the aforesaid system, and with reference to FIG. 5, the method of communication between the electronic apparatus 31 and the server 5 will now be described in greater detail in the succeeding paragraphs.

Initially, in step 71, the electronic apparatus 31 and the server 5 are turned on. In actual practice, the operating software stored in the storage media 313, 56 are loaded into the electronic apparatus 31 and the server 5, respectively, after activation of the latter, and the operating environments of the electronic apparatus 31 and the server 5 are compatible.

Subsequently, in step 72, the electronic apparatus 31 and the server 5 begin to drive the peripheral devices thereof. The microprocessor 312 of the electronic apparatus 31 operates to retrieve the initialization settings and software that are stored in the storage medium 313 to drive the network interface card 314, the host control interface 315 and the first wireless transmission device 32, and to establish data transmission between the network interface card 314 and the host control interface 315 and between the host control interface 315 and the first wireless transmission device 32. As such, signals can be processed via the network interface card 314 into data packets that conform to the TCP/IP standard and that are broadcast in the form of radio waves together with the destination code and the origin code by the first wireless transmission device 32 via the host control interface 315. Conversely, during signal reception, after the first wireless transmission device 32 has verified the received radio signal (i.e., the destination code is the same as the first identification code exclusive thereto), the data packets are decrypted via the host control interface 315 and the network interface card 314. The microprocessor 312 also determines the subsequent processing of the signal (to be described hereinafter) The microprocessor 52 of the server 5 retrieves the initial settings and software that are stored in the storage media 56 to drive the network interface card 53, the host control interface 54, the monitoring unit 55, and the second wireless transmission device 33, and establishes the data transmission link between the network interface card 53 and the host control interface 54 and between the host control interface 54 and the second wireless transmission device 33. As such, radio signals can be transmitted or received via the second wireless transmission device 33.

In step 73, it is determined whether a communications link between the electronic apparatus 31 and the server 5 has been established. Since data transmission channels, in the form of virtual circuits, are required between the electronic apparatus 31 and the server 5 to ensure proper transmission of data therebetween, the radio signals transmitted by the first wireless transmission device 32 and the second wireless transmission device 33 will include, in addition to the signal information to be transmitted, the destination and origin codes. As such, when the electronic apparatus 31 transmits a signal to the server 5, the signal is processed by the first wireless transmission device 32 to include the first identification code exclusive thereto (i.e. the origin code) and the second identification code of the second wireless transmission device 33 connected to the server 5 (i.e. the destination code) . After the signal is broadcast via the first wireless transmission device 32, the signal can be relayed via a communications tower to propagate through the air so that it can be received by both the first and second wireless transmission devices 32, 33. Since the radio signal includes the destination code, the second wireless transmission device 33 can identify the signal as one addressed thereto, whereas the server 5 can identify the electronic apparatus 31 to thereby establish the communications link between the electronic apparatus 31 and the server 5. Hence, the electronic apparatus 31 can perform a test to determine whether a signal can be transmitted to or received from the server 5 via the first wireless transmission device 32, and whether the server 5 can transmit or receive a signal to or from the electronic apparatus 31 via the second wireless transmission device 33 to thereby ensure that the communications link between the electronic apparatus 31 and the server 5 has been established. If it is determined that the communications link has been established, the flow goes to step 74. Otherwise, the flow returns to step 72 to continue with the construction of the communications link.

In step 74, it is determined whether the monitoring software of the server 5 and the monitoring unit 55 cooperating therewith are activated and are functioning normally. In this embodiment, the monitoring software and the monitoring unit 55 are configured to be activated simultaneously with the server 5 when the latter is turned on in step 71. The monitoring function of the monitoring unit 55 includes monitoring and warning tasks. The monitoring task includes monitoring the temperature of the server 5, microprocessor operation, memory utilization, hard disk utilization, system performance efficiency, system information, event recording, device information and the like, the monitored information being collected to generate a monitoring report, and monitoring changes in the various information so as to timely update the contents of the monitoring report. When the server 5 malfunctions during execution of the monitoring task, the warning task will be activated to generate a warning signal to the electronic apparatus 31 such that, upon receipt of the warning signal, the electronic apparatus 31 will be able to identify the malfunctioning server 5 (to be described hereinafter)

In step 75, if it is determined in step 74 that the monitoring function of the server 5 has not been set up, the monitoring software and the monitoring unit 55 will be activated once again, and the flow will subsequently go to step 76.

In step 76, since a communications link has been established between the electronic apparatus 31 and the server 5, when it is desired to setup or control the server 5, a control command can be inputted via the user input device 317 of the electronic apparatus 31. The control command can be formatted via the network interface card 314 and transmitted sequentially to the host control interface 315 and the first wireless transmission device 32 for broadcasting in the form of radio waves. The microprocessor 52 of the server 5 can determine whether the electronic apparatus 31 has sent a control command thereto based upon whether the destination code of the control command matches the exclusive second identification code of the respective second wireless transmission device 33. After the server 5 has verified the presence of a control command from the electronic apparatus 31, the flow goes to step 77. Otherwise, the flow goes directly to step 78.

In step 77, the microprocessor 52 of the server 5 will execute a routine according to the control command. Therefore, the electronic apparatus 31 can initialize the server 5 in this manner without having to be disposed in the vicinity of the latter. The electronic apparatus 31 can also send a command to the server 5 in the same manner so that the monitoring report can be transmitted thereto wirelessly. Hence, the electronic apparatus 31 can utilize the screen 316 (see FIG. 4) to permit viewing of the status of the server 5 at any time, and need not be disposed in the same machine room with the server 5 or connected to the server 5 via network lines or the like. As such, the position of the electronic apparatus 31 is more flexible as compared to the conventional server management methods described above, and the electronic apparatus 31 can be used to control a greater number of the servers 5.

In step 78, the monitoring function of the server 5 determines whether there is any abnormal condition, for instance, the detection of a server temperature higher than the predetermined temperature or a system problem, etc. In the affirmative, the flow goes to step 79. Otherwise, the flow goes directly to step 80.

In step 79, when the monitoring unit 55 detects that the temperature of the server 5 is higher than the predetermined temperature, it will generate a warning signal. The microprocessor 52 will transmit the warning signal to the electronic apparatus 31 to notify the operator of the server management system 3 that the temperature of the server 5 is excessively high. When the monitoring software has determined that a system problem has occurred, a warning signal will be similarly generated. The microprocessor 52 will transmit the warning signal to the electronic apparatus 31 to alert the operator. Hence, once the server 5 has experienced a problem, a command can be made to request a monitoring report from the server 5 so that the operator can locate the source of the problem by reviewing the monitoring report. Therefore, problems, such as system setting error, can be solved by directly inputting a correction command via the user input device 317 of the electronic apparatus 31, which is more convenient as compared to the aforesaid prior art in which the operator has to be physically present in the machine room so as to be able to check and repair the server 5.

In step 80, the microprocessor 52 of the server 5 inspects whether a stop command has been received from the electronic apparatus 31. In the negative, the flow returns to step 76, and steps 76 to 79 are executed once again. Otherwise, the flowproceeds to step 81. The stop command is sent by the electronic apparatus 31 when it is desired to terminate server management via the electronic apparatus 31.

Finally, in step 81, once the server 5 has received the stop command, the communications link between the electronic apparatus 31 and the server 5, as well as the monitoring function of the server 5 being controlled by the electronic apparatus 31, is stopped.

In actual practice, the signals to be transmitted between the electronic apparatus 31 and the server 5 can be made to comply with network transmission standards without going through the network interface card 314, and can be transmitted directly via the host control interface 315 and the wireless transmission devices 32, 33.

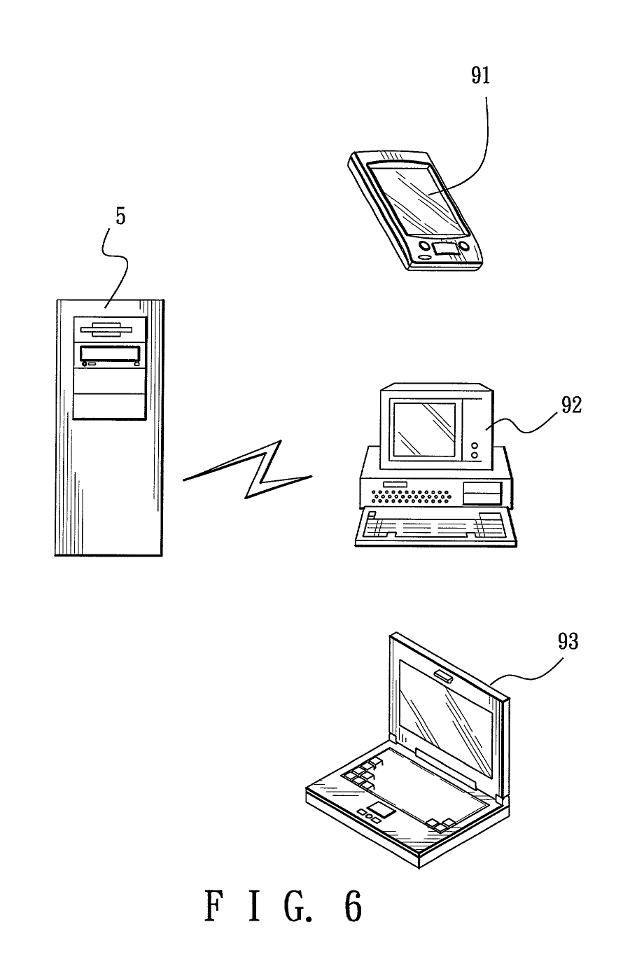

Although the electronic apparatus 31 controls a single server 5 in this embodiment, the electronic apparatus 31 is not limited thereto and can be configured to control a plurality of servers 5 in actual practice, as shown in FIG. 4. Besides, while the electronic apparatus 31 is a personal computer in this embodiment, it can also be a personal digital assistant (PDA) 91, a workstation 92, a notebook computer 93, as shown in FIG. 6, or the like, so long as the construction and functions disclosed above are present.

In sum, the present invention is capable of achieving the following advantages:

1. Wireless Management of Servers:

In the invention, the electronic apparatus 31 and the server 5 respectively work in conjunction with the first and second wireless transmission devices 32, 33 such that the electronic apparatus 31 can send commands to the server 5 via the first wireless transmission device 32 in the form of radio waves, while the server 5 can receive the commands via the second wireless transmission device 33 and can timely transmit information signals (such as warning signals and monitoring reports) to the electronic apparatus 31 via the second wireless transmission device 33. As such, the electronic apparatus 31 can monitor and control the server 5 at any time. During propagation of these commands and signals, a number of communication towers may be provided to minimize signal attenuation and avoid signal loss. By virtue of wireless signal transmission, unlike the aforesaid conventional server management systems, the electronic apparatus 31 of the invention does not have to be physically connected to the servers in order to setup or monitor the same, and is not required to be disposed in the machine room where space is limited.

2. Enhanced Management Stability and Security:

Since the management system 3 of the invention employs wireless signal transmission, even if Internet connection is unavailable, the electronic apparatus 31 can still monitor the status of the servers 5 to check whether any of the servers 5 has experienced a problem.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for wireless management of a server, comprising the steps of:
providing an electronic apparatus that is operable so as to issue commands for the server;
connecting a first wireless transmission device to the electronic apparatus, the first wireless transmission device having a first identification code exclusive thereto;
connecting a second wireless transmission device to the server, the second wireless transmission device having a second identification code exclusive thereto;
storing the second identification code in the first wireless transmission device; and
establishing a wireless communications link between the electronic apparatus and the server via the first and second wireless transmission devices,
wherein, when the electronic apparatus is operated to issue a command to the server, the first wireless transmission device transmits a wireless output that includes the command, the first identification code exclusive to the first wireless transmission device to serve as an origin code, and the second identification code exclusive to the second wireless transmission device to serve as a destination code, and
wherein, when the second wireless transmission device receives the wireless output, the second wireless transmission device provides the command in the wireless output to the server only upon verification that the destination code matches the second identification code exclusive thereto.

2. The method of claim 1, wherein the second wireless transmission device stores the first identification code therein upon verification that the destination code matches the second identification code exclusive thereto.

3. The method of claim 2, the server being capable of generating a warning signal upon detection of a server abnormality or server problem and of providing a monitoring report in response to a request from the electronic apparatus,
wherein, upon receipt of either one of the warning signal and the monitoring report from the server, the second wireless transmission device transmits a wireless signal that includes said either one of the warning signal and the monitoring report, the first identification code exclusive to the first wireless transmission device to serve as a destination code, and the second identification code exclusive to the second wireless transmission device to serve as an origin code, and
wherein, when the first wireless transmission device receives the wireless signal, the first wireless transmission device provides said either one of the warning signal and the monitoring report in the wireless signal to the electronic apparatus only upon verification that the destination code matches the first identification code exclusive thereto.

4. A system for wireless management of a server, comprising:
an electronic apparatus operable so as to issue commands for the server;
a first wireless transmission device connected to said electronic apparatus and having a first identification code exclusive thereto; and
a second wireless transmission device adapted to be connected to the server and having a second identification code exclusive thereto;
the second identification code being stored in the first wireless transmission device;
said first and second wireless transmission devices cooperating to establish a wireless communications link between said electronic apparatus and the server;
wherein, when said electronic apparatus is operated to issue a command to the server, said first wireless transmission device transmits a wireless output that includes the command, the first identification code exclusive to said first wireless transmission device to serve as an origin code, and the second identification code exclusive to said second wireless transmission device to serve as a destination code; and
wherein, when said second wireless transmission device receives the wireless output, said second wireless transmission device provides the command in the wireless output to the server only upon verification that the destination code matches the second identification code exclusive thereto.

5. The system of claim 4, wherein said second wireless transmission device stores the first identification code therein upon verification that the destination code matches the second identification code exclusive thereto.

6. The system of claim 5, the server being capable of generating a warning signal upon detection of a server abnormality or server problem and of providing a monitoring report in response to a request from said electronic apparatus,
wherein, upon receipt of either one of the warning signal and the monitoring report from the server, said second wireless transmission device transmits a wireless signal that includes said either one of the warning signal and the monitoring report, the first identification code exclusive to said first wireless transmission device to serve as a destination code, and the second identification code exclusive to said second wireless transmission device to serve as an origin code, and
wherein, when said first wireless transmission device receives the wireless signal, said first wireless transmission device provides said either one of the warning signal and the monitoring report in the wireless signal to said electronic apparatus only upon verification that the destination code matches the first identification code exclusive thereto.

7. The system of claim 6, wherein said electronic apparatus is one of a personal computer, a workstation, a personal digital assistant and a notebook computer.

8. The system of claim 6, wherein the wireless communications link conforms to one of the infrared communication standard, the Bluetooth communication standard, the IEEE 802.11b communication standard, and the Wireless Application Protocol.
